(19) United States
(12) Patent Application Publication
(10) Pub. No.: US 2006/0164538 A1
(43) Pub. Date: Jul. 27, 2006

(54) Lens unit and image pickup unit

(75) Inventors: Toyotoshi Kawasaki, Osaka (JP); Toru Kuchimaru, Toyokawa-shi (JP); Hiroyoshi Hosota, Toyokawa-shi (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/339,884

(22) Filed: Jan. 26, 2006

(30) Foreign Application Priority Data
Jan. 27, 2005 (JP) 2005-019440
Nov. 21, 2005 (JP) 2005-335166

(51) Int. Cl. H04N 5/225; G02B 13/16

(52) U.S. Cl. 348/335

(57) ABSTRACT

A lens unit or an image pickup unit including an image pickup device in addition to the lens unit comprises a base member located on an image pickup device side and a cover member to be directed to an object side. A slider is attached to the cover member to be axially movable. The slider is to hold the lens or a lens holder. A piezoelectric element actuator for driving the slider is also attached to the cover member. Thus, only a back face of the base member has to be adapted to various types of image pickup devices. A front face thereof may be formed in a simple shape for attachment of the base member to the cover member. Accordingly, the lens unit and the image pickup unit can easily conform to various types of image pickup devices. Further, the inner shape of the lens holder can be adapted to various types of lenses, so that the lens unit needs no change in structure.

### CROSS-REFERENCE TO RELATED APPLICATIONS

This application is based upon and claims the benefit of priority from each of the prior Japanese Patent Applications No. 2005-019440 filed on Jan. 27, 2005 and No. 2005-335166 filed on Nov. 21, 2005, the entire contents of which are incorporated herein by reference.

### BACKGROUND OF THE INVENTION

1. Field of the Invention

The present invention relates to a lens unit to be used in an optical system of an imaging device such as a camera, and an image pickup unit including such lens unit and additionally an image pickup device, and more particularly to a lens unit and an image pickup unit having enhanced general versatility with respect to the types of image pickup devices.

2. Description of Related Art

Recently, a camera has been mounted even in compact electronic equipment such as a mobile communications terminal. A lens unit or an image pickup unit for this type of camera built in compact equipment is disclosed in for example Japanese unexamined patent publication No. 2002-107612. Such lens unit typically comprises a base member located on an image pickup device side and a cover member to be placed on an object side. The lens and its peripheral parts are mounted on the base member and the front face of the lens unit is covered by the cover member.

However, the conventional lens unit and image pickup unit as mentioned above have the following defects. Specifically, they are designed likewise for use in compact equipment but various types of image pickup devices are used therein to coincide with respective required specs. Also, there are many types of lenses to be used. Accordingly, the base member for the conventional lens unit and image pickup unit need to be configured to have a mounting portion whose shape matches any one of various types of image pickup devices and lenses. The number of types of base members is therefore required as much as the number of combinations of the image pickup devices and lenses. This would cause complication in design.

### SUMMARY OF THE INVENTION

The present invention has been made in view of the above circumstances and has an object to overcome the above problems and to provide a lens unit and an image pickup unit that can easily conform to any type of image pickup device. Additional objects and advantages of the invention will be set forth in part in the description which follows- and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a lens unit comprising: a base member to be attached to an image pickup device; a cover member attached to the base member; and a slider that holds a lens or a lens holder, the slider being placed between the base member and the cover member, and attached to the cover member so as to be movable in an axial direction.

According to another aspect of the present invention, there is provided an image pickup unit further comprising an image pickup device attached to the base member of the lens unit of the present invention. The lens unit or image pickup unit of the present invention is preferably arranged such that a driving member for axially moving the slider is provided to the cover member.

In the lens unit or image pickup unit of the present invention, the slider is held by the cover member, not by the base member. Since the base member does not hold the lens and its moving mechanism, the front face of the base member may be formed in a simple shape. Only the back face of the base member is required to have the shape conforming to an image pickup device. The cover member and the slider may be common to any types of image pickup devices. Thus, the lens unit or image pickup unit can easily conform to any type of the image pickup devices respectively and also be manufactured with use of dies, one of which for the base member on the back face side has only to be selected for the type of the image pickup device.

The lens unit or image pickup unit of the present invention may be provided with the attachment function unit including a shutter and others. In this case, the attachment function unit is preferably one attachable to the base member. Preferably, the cover member is located between the base member and the attachment function unit. With such arrangement, either case; the presence or absence of the attachment function unit, can be supported by the base member alone.

According to the present invention, the lens unit and the image pickup unit that can easily conform to any types of image pickup devices can be achieved.

### BRIEF DESCRIPTION OF THE DRAWINGS

In the drawings,

FIG. 1 is an exploded perspective view of a lens unit in a first embodiment;

FIG. 2 is a perspective view of an image pickup unit in the first embodiment;

FIG. 3 is a sectional view of the lens unit in the first embodiment; and

FIG. 4 is an exploded perspective view of a lens unit in a second embodiment.

### DETAILED DESCRIPTION OF THE PREFERRED EMBODIMENTS

### First Embodiment

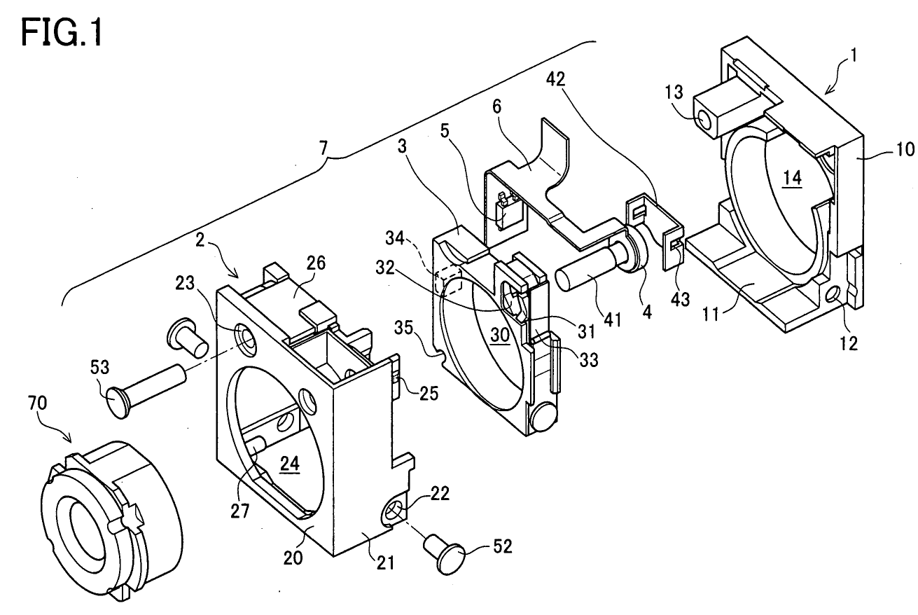

A detailed description of a preferred embodiment of the present invention will now be given referring to the accompanying drawings. In this embodiment, the present invention is applied to a lens unit for a camera to be equipped in a cellular phone. The structure of the lens unit in the present embodiment is explained with reference to FIG. 1, which is an exploded perspective view. The lens unit in the present embodiment includes a base member 1 and a cover member 2.

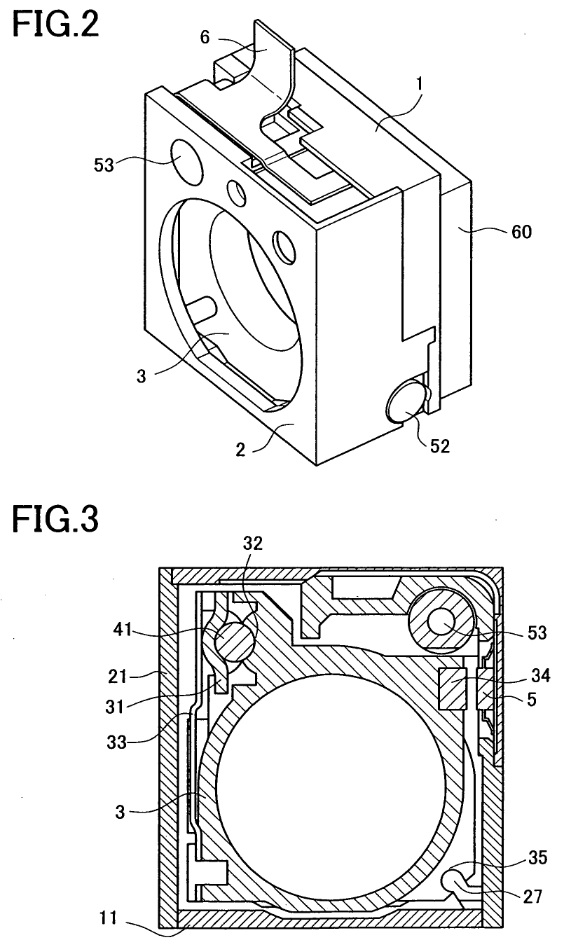

The base member 1 is attached, at its back side, to an image pickup device 60 (see FIG. 2) and attached, at its front side, to the cover member 2. The base member 1 includes a base part 10 whose entire shape is substantially square and a side part 11 provided on the front side of the base part 10 along its lower edge in the figure. The front face of the base member 1 is formed in various shapes (screw holes 12 and 13, and others) for attachment to the cover member 2. The back face of the base member 1 is formed in a shape adequate for attachment to the image pickup device 60. Further, the base part 10 is formed with a light passing hole 14.

The cover member 2 is attached to the base member 1 at its front side. The cover member 2 includes a face part 20 whose entire shape is substantially square and a side part 21 provided surrounding the periphery of the face part 20 but its bottom back side in the figure. The cover member 2 and the base member 1 assembled together is box-shaped as a whole. The cover member 2 is formed with various shapes (screw holes 22 in the side part 21, screw holes 23 in the face part 20, and others) for attachment to the base member 1. The face part 20 is further formed with a lens hole 24. The side part 21 is formed with protrusions 25 for connection with a slider 3 which will be mentioned later, a guide shaft 27 for guiding axial movement of the slider 3, and a recess 26 in which a flexible board 6 is set. Those protrusions 25 and guide shaft 27 are provided for connecting the slider 3 and others to the cover member 2. The recess 26 is formed extending from the top side of the side part 21 to the back side thereof which is invisible in the figure.

The lens unit in the present embodiment further comprises the slider 3, a piezoelectric element actuator 4, a hall element 5, and a pressure plate 42. These are located between the base member 1 and the cover member 2. The slider 3 is movable in an axial direction of the lens while holding the lens holder 70. The piezoelectric element actuator 4 is used to axially drive the slider 3. The hall element 5 is used to detect the position of the slider 3 in the axial direction. The piezoelectric element actuator 4 and the hall element 5 are arranged to transmit/receive signals to/from any external device through the flexible board 6. The pressure plate 42 is a member for fixing the piezoelectric element actuator 4 to the cover member 2 in cooperation with the protrusions 25 of the cover member 2. For this end, the pressure plate 42 is formed with holes 43 in which the protrusions 25 are engaged.

The slider 3 is formed with a lens hole 30 in which the lens holder 70 is mounted. The slider 3 is also provided with a retaining lug 31 and a recess 32, which serve to retain a drive part 41 of the piezoelectric element actuator 4 therebetween. Specifically, this retaining lug 31 retains the drive part 41 in cooperation with the recess 32 by an urging force of a blade spring 33. The slider 3 is further formed with a guide recess 35 which engages the guide shaft 27 of the cover member 2. The slider 3 has a built-in magnet 34 for allowing the hall element 5 to detect the position of the slider 3.

An assembling procedure of the lens unit in the present embodiment will be described below. Firstly, the drive part 41 of the piezoelectric element actuator 4 is pushed into a clearance between the retaining lug 31 and the recess 32 in the slider 3. Thus, the slider 3 becomes drivable by the piezoelectric element actuator 4. The slider 3 is then inserted into the cover member 2 so that the guide shaft 27 of the cover member 2 is engaged in the guide recess 35 of the slider 3. The flexible board 6 and the hall element 5 are disposed outside the side part 21 of the cover member 2, that is, they are set in the recess 26. Accordingly, the hall element 5 faces the magnet 34. The piezoelectric actuator 4 is then covered by the pressure plate 42 with the holes 43 engaging the protrusions 25 of the cover member 2.

In this state, all components covered by reference numeral “7” in FIG. 1 are assembled into one, which will be referred to as a “versatile AF unit” 7. The base member 1 is attached to the back of this versatile AF unit 7. Further, screws 52 are threaded into the screw holes 12 and 22, while the screws 53 are threaded into the screw holes 13 and 23. In the above way, the lens unit in the present embodiment is assembled.

In the lens unit in the present embodiment, an appropriate driving signal is supplied to the piezoelectric element actuator 4 through the flexible board 6 to move the slider 3. At this time, the slider 3 is prevented from rotating by the guide shaft 27 of the cover member 2 and therefore is allowed to axially move with respect to the cover member 2. The magnet 34 is also moved together with the slider 3. Accordingly, the position of the slider 3 in the axial direction is detected by the hall element 5 and thus can be controlled appropriately.

The lens unit is attached, at its back (on the base member 1 side), to the image pickup device 60, thus providing an image pickup unit. This state is shown in FIG. 2 which is a perspective view thereof. FIG. 3 shows a sectional view of this lens unit. The lens unit or image pickup unit is arranged to allow the lens holder 70 to be mounted in the lens hole 30 of the slider 3 through the lens hole 24 formed in the front face of the unit (on the cover member 2 side). Alternatively, the lens holder 70 may be mounted in advance in the slider 3. Of course a lens has been set in the lens holder 70. The front face (the cover member 2 side) of the unit with the lens holder 70 being mounted will be directed to an object side.

The lens unit in the present embodiment can provide the following advantages. Specifically, the lens unit can easily conform to any type of image pickup device. Generally used is a lens having a diameter corresponding to the size of an imaging area of the image pickup device. Available lenses are various in types (sizes), accordingly. The lens unit in the present embodiment can easily conform to such many types of lenses. The reason thereof will be explained below.

Firstly, a reason why the lens unit in the present embodiment can easily conform to various types of image pickup devices is in that the cover member 2, not the base member 1, takes on the holding of the slider 3 and its driving mechanism. Specifically, the base member 1 has no shape appropriate for holding the slider 3 and its driving mechanism. The base member 1 has only to have a simple shape at its front side for connection with the cover member 2. The art for which individual design is required according to the type of an image pickup device to be used is only a portion of the base member 1, particularly, its back side. Since the front side of the base member 1 is a simple shape, there are very few restrictions in designing the shape of the back side thereof. Thus, only a small number of man-hours is needed for development of every type of image pickup device. Even in the case where an order of a lens unit for a new type of an image pickup device is received, such lens unit can be fabricated promptly. As for manufacturing, only appropriate selection of a die to be used for the back side of the base member 1 is required according to the type of the image pickup device. As for other parts of the lens unit, the same dies may be used regardless of the type of the image pickup device to be mounted.

Secondly, a reason why the lens unit in the present embodiment can easily conform to many types of lenses is in that the lens holder 70 is set in the lens holder 30 of the slider 3. Specifically, the lens unit is not structured to directly drive the lens or the lens holder 70 by the piezoelectric element actuator 4. If the lens holder 70 is designed to have an outer diameter corresponding to the diameter of the lens hole 30, the lens unit may conform to any types of lenses according to only an inner shape of the lens holder 70. Even though the diameter of a lens to be used has an upper limit, any lenses having the diameter smaller than the upper limit may be mounted in the lens unit in the present embodiment. Further, the lens itself may be mounted directly in the lens holder if the peripheral shape of the lens itself matches the inner shape of the lens hole 30 of the slider 3.

As explained above in detail, the lens unit and the image pickup unit in the present embodiment include the slider 3 for holding the lens holder 70. The slider 3 and its driving mechanism are attached to the cover member 2. This arrangement can achieve the lens unit and the image pickup unit that can easily conform to many types of image pickup devices and lenses.

### Second Embodiment

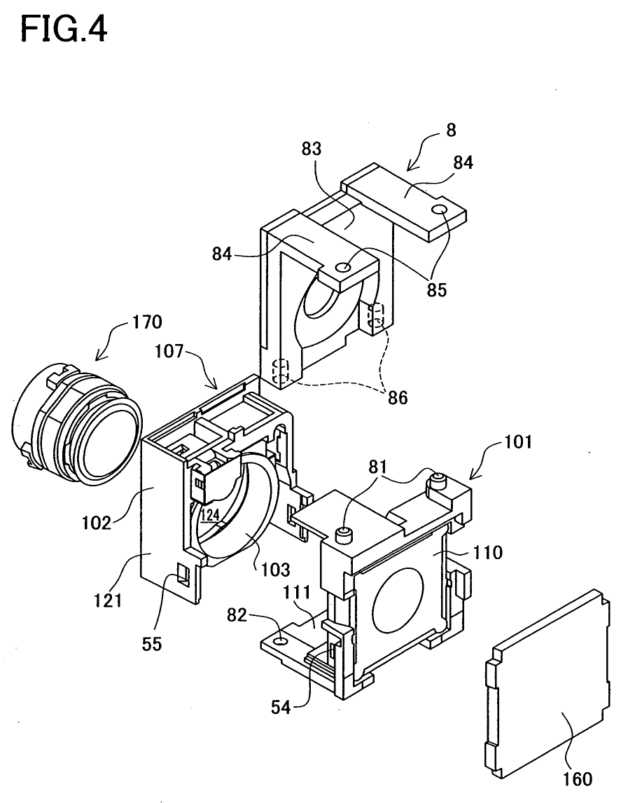

A second embodiment of the present invention will be described below with reference to FIG. 4. Also in this embodiment, the present invention is applied to a lens unit for a camera to be equipped in cellular phone. The structure of the lens unit in the present embodiment will be explained with reference to FIG. 4, which is an exploded perspective view. The lens unit in the present embodiment includes a base member 101 and a versatile AF unit 107. A substantially common structure to that in the first embodiment will be represented by a reference number added to 100, but not be explained herein. In this figure, the slider 103 and others are attached to a cover member 102, configuring the versatile AF unit 107.

The lens unit in the present embodiment is provided with a shutter unit 8 attached to the base member 101. In a state where the shutter unit 8 is attached to the base member 101, the versatile AF unit 107 is located between the base member 101 and the shutter unit 8. A lens holder 170 is mounted in a lens hole 124 of the versatile AF unit 107 which is fixed to the base member 101. The base member and the cover member in the first embodiment are fixed to each other with the screws tightened in the screw holes, whereas the base member 101 and the cover member 102 in the second embodiment are fixed to each other with protrusions 54 (only one of which is shown in FIG. 4) provided to a base part 110 of the base member 101 so that the protrusions 54 are engaged in holes 55 formed in a side part 121 of the cover member 102.

In the present embodiment, as shown in FIG. 4, positioning bosses 81 are formed on the top of the base part 110 of the base member 101. A side part 111 of the base member 101 is formed with two holes 82 (only one is shown in FIG. 4). The shutter unit 8 includes a face part 83 placed in front of the versatile AF unit 107 and a pair of arm parts 84 which cover the top of the versatile AF unit 107. The shutter structure is built in the face part 83. Further, each arm part 84 is formed with a positioning hole 85. The face part 83 is further formed in its bottom with screw holes 86.

An assembling procedure of the lens unit in the second embodiment begins with assembling of the versatile AF unit 107 as in the first embodiment, and then the base member 101 and the lens holder 170 are attached thereto. Thereafter, the shutter unit 8 is attached, from left in FIG. 4, to the base member 101 with the versatile AF unit 107 being combined therewith. At this time, the positioning holes 85 of the shutter unit 8 are fitted on the bosses 81 of the base member 101. Screws are then tightened from under the base member 101 into the screw holes 86 through the holes 82 of the base member 101. With this arrangement, the shutter unit 8 is fixed to the base member 101. In this state, the face part 83 of the shutter unit 8 covers the front face of the versatile AF unit 107. An image pickup device 160 is attached onto the back face of the base member 101.

The lens unit having the above structure in the second embodiment, as with the lens unit in the first embodiment, can conform to various types of image pickup devices and lenses. The lens unit can conform to either case; the presence or absence of the attachment parts such as the shutter unit 8. In the case where an order of a lens unit with the shutter unit 8 is received, the front face of the base member 101 has only to be slightly changed in shape to receive the shutter unit 8. In other words, the lens unit in the present embodiment can respond to such order without needing any changes in the versatile AF unit 107 and the lens holder 170. Consequently, the lens unit in the present embodiment allows the use of many types of image pickup devices and lenses and any combination thereof with the presence/absence of any combination.

As described above in detail, the lens unit and image pickup unit in the present embodiment also can realize the lens unit and image pickup unit conformable to various types of image pickup devices and lenses and also the combination of the presence/absence of attachment parts with them.

The above embodiments are merely examples and the present invention may be embodied in other specific forms without departing from the spirit or essential characteristics thereof.

For instance, the driving source of the slider 3 is not limited to the piezoelectric element actuator. For example, a stepping motor or another member such as a lever which axially moves the slider 3 by manual operation may be used. Concrete shape of each part or portion may be changed from the illustrated one. The attachment part attached to the base member with the versatile AF unit interposed therebetween is not limited to the shutter unit 8. For example, the attachment part may be a diaphragm, hood, converter, filter, or any combination of them.

What is claimed is:

1. A lens unit comprising:
a base member to be attached to an image pickup device;
a cover member attached to the base member; and
a slider that holds a lens or a lens holder, the slider being placed between the base member and the cover member, and attached to the cover member so as to be movable in an axial direction.

2. The lens unit according to claim 1, further comprising a driving member that is attached to the cover member and is arranged to axially move the slider.

3. The lens unit according to claim 1, further comprising an attachment function unit attached to the base member,
wherein the cover member is located between the base member and the attachment function unit when the attachment function unit is attached to base member.

4. The lens unit according to claim 1, wherein the cover member is provided with a guide shaft for guiding axial movement of the slider.

5. The lens unit according to claim 1, further comprising a pressure plate that fixes the driving member to the cover member,
wherein the cover member is formed with a protrusion that attaches the pressure plate to the cover member.

6. The lens unit according to claim 1, further comprising a position detecting element attached to the cover member for detecting a position of the slider in the axial direction.

7. The lens unit according to claim 6, further comprising a flexible board whereby the driving member and the position detecting element make signal communication to an external device,
wherein the cover member is formed with a recess in which the flexible board is set.

8. The lens unit according to claim 3,
wherein the base member comprises:
a base part having a back face on which the image pickup device is to be attached; and
a side part provided on a front face side of the base part along its one edge,
wherein the attachment function unit comprises:
a face part located on a front face of the cover member; and
an arm part that covers the side face of the cover member and the side face of the base part of the base member,
and wherein the side face of the base part of the base member, the side part of the base member, the side face of the face part of the attachment function unit, and the arm part of the attachment function unit are formed with shapes for fixing the base member to the attachment function unit.

9. An image pickup unit comprising:
an image pickup device;
a base member attached to the image pickup device;
a cover member attached to the base member; and
a slider that holds a lens or a lens holder, the slider being placed between the base member and the cover member, and attached to the cover member so as to be movable in an axial direction.

10. The image pickup unit according to claim 9, further comprising a driving member that is attached to the cover member and is arranged to axially move the slider.

11. The image pickup unit according to claim 9, further comprising an attachment function unit attached to the base member,
wherein the cover member is located between the base member and the attachment function unit when the attachment function unit is attached to base member.

12. The image pickup unit according to claim 9, wherein the cover member is provided with a guide shaft for guiding axial movement of the slider.

13. The image pickup unit according to claim 9, further comprising a pressure plate that fixes the driving member to the cover member,
wherein the cover member is formed with a protrusion that attaches the pressure plate to the cover member.

14. The image pickup unit according to claim 9, further comprising a position detecting element attached to the cover member for detecting a position of the slider in the axial direction.

15. The image pickup unit according to claim 14, further comprising a flexible board whereby the driving member and the position detecting element make signal communication to an external device,
wherein the cover member is formed with a recess in which the flexible board is set.

16. The image pickup unit according to claim 11,
wherein the base member comprises:
a base part having a back face on which the image pickup device is to be attached; and
a side part provided on a front face side of the base part along its one edge,
wherein the attachment function unit comprises:
a face part located on a front face of the cover member; and
an arm part that covers the side face of the cover member and the side face of the base part of the base member,
and wherein the side face of the base part of the base member, the side part of the base member, the side face of the face part of the attachment function unit, and the arm part of the attachment function unit are formed with shapes for fixing the base member to the attachment function unit.
